(19) United States
(12) Patent Application Publication
(10) Pub. No.: US 2013/0302611 A1
(43) Pub. Date: Nov. 14, 2013

(54) ORDERED MESOPOROUS CARBON-CARBON NANOTUBE NANOCOMPOSITES AND METHOD FOR MANUFACTURING THE SAME

(71) Applicants: Sang-Hoon Joo, Ulsan (KR); Jae-Yeong Cheon, Ulsan (KR); Jae-Deuk Kim, Yeoju-gun (KR); Jung-Hyun Park, Yongin (KR)

(72) Inventors: Sang-Hoon Joo, Ulsan (KR); Jae-Yeong Cheon, Ulsan (KR); Jae-Deuk Kim, Yeoju-gun (KR); Jung-Hyun Park, Yongin (KR)

(73) Assignees: DH Holdings Co., Ltd., Ulsan (KR); UNIST Academy-Industry Research Corporation, Ulsan (KR)

(21) Appl. No.: 13/530,270

(22) Filed: Jun. 22, 2012

(30) Foreign Application Priority Data
May 9, 2012 (KR) 10-2012-0049248

(51) Int. Cl. H01B 1/04; B82Y 40/00; B82Y 30/00

(52) U.S. Cl. 428/402; 252/502; 977/784; 977/900

(57) ABSTRACT

Disclosed are ordered mesoporous carbon-carbon nanotube nanocomposites and a method for manufacturing the same. The method for manufacturing ordered carbon-carbon nanotube nanocomposites according to the present invention includes: forming a mixture of a carbon precursor and ordered mesoporous silica; carbonizing the mixture to form a ordered mesoporous silica-carbon composite; and removing the mesoporous silica from the ordered mesoporous silica-carbon composite.

### CROSS-REFERENCE TO RELATED APPLICATION

This application claims priority to and the benefit of Korean Patent Application No. 10-2012-0049248 filed in the Korean Intellectual Property Office on May 9, 2012, the entire contents of which are incorporated herein by reference.

### BACKGROUND OF THE INVENTION

(a) Field of the Invention

The present invention relates to nanocomposites, and more particularly, to ordered mesoporous carbon-carbon nanotube nanocomposites.

(b) Description of the Related Art

In energy conversion and storage devices, such as fuel cells, lithium-air batteries and the like, catalysts which promote electrochemical reactions are very important, and thus various attempts to enhance the activity of these catalysts have been made.

The activity of catalyst is improved as the reaction surface area of a catalyst increases, and thus it is required that the particle diameter of the catalyst is reduced to increase the reaction surface area and particles are uniformly distributed on the electrode.

For this purpose, catalyst supports also need to have a wide surface area and thus studies thereof have been actively performed.

A catalyst support for an energy conversion and storage device needs to have not only a wide surface area deduced by porosity but also electric conductivity for serving as a passage through which electrons flow. As the catalyst support, amorphous microporous carbon powders known as activated carbon and carbon black, ordered carbon molecular materials and the like have been broadly used.

However, it is known that these amorphous microporous carbon powders have poor interconnection among micropores. Thus, in polymer electrolyte fuel cells in the related art, a supported catalyst using amorphous microporous carbon powder as a support is considerably deteriorated in terms of reactivity, compared to a catalyst in which a metal particle itself is used as a catalyst.

However, when the metal particle itself is used as a catalyst, a large amount of the catalyst is used, and thus the manufacturing costs of the electrode increase, thereby directly increasing the costs of the fuel cell. Accordingly, the development of a supported catalyst that may further improve catalytic reactivity is urgently required.

For this purpose, ordered mesoporous carbon materials were used as a carbon support material for a fuel cell. In ordered mesoporous carbons, mesopores larger than micropores are regularly connected and advantageous in delivery and transport of materials, and thus reactivity is greatly improved, compared to when microporous carbon is used as a support.

However, when ordered mesoporous carbon is used as a support material for energy transformation and conversion, the interfacial resistance between ordered mesoporous carbons and particles is present, and thus the efficient movement of electrons may be inhibited.

The above information disclosed in this background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide ordered mesoporous carbon-carbon nanotube nanocomposites and a method for manufacturing the same having advantages of improving electric conductivity.

An exemplary embodiment of the present invention provides ordered mesoporous carbon-carbon nanotube nanocomposites having a structure in which ordered mesoporous carbons having mesopores and carbon nanotubes are connected with each other.

The mesopores may have an average diameter of from 2 nm to 30nm.

The nanocomposites may have a specific surface area of from 200 m²/g to 2,000 m²/g and a sheet resistance of from 0.1 Ω/□ to10 Ω/□.

When the nanocomposites are subjected to X-ray diffraction analysis, a main peak of Bragg angle (2θ) for a CuK-α characteristic X-ray wavelength 1.541 Å may appear from 0.5 to 1.5.

Another exemplary embodiment of the present invention provides a method for manufacturing ordered mesoporous carbon-carbon nanotube nanocomposites, including: forming a mixture of a carbon precursor and ordered mesoporous silica; carbonizing the mixture to form a ordered mesoporous silica-carbon composite; and removing the mesoporous silica from the ordered mesoporous silica-carbon composite.

A content of the ordered mesoporous silica mixed with the carbon precursor may be from 50 parts by weight to 300 parts by weight based on 100 parts by weight of the carbon precursor.

The carbon precursor may be at least one macrocyclic compound to which a metal ion is coordinated, selected from phthalocyanine, porphyrin, hemin and corrole.

The ordered mesoporous silica may be a molecular material having a three-dimensional connection structure and may be at least one selected from MCM-48, SBA-1, SBA-6, SBA-16, KIT-5, KIT-6, FDU-1 and FDU-12, which have a cubic structure, SBA-15 which has a hexagonal structure, KIT-1 and MSU-1, which have a structure in which pores are irregularly and three-dimensionally connected.

Further, the ordered porous silica may be a mesoporous molecular material having a structure in which one-dimensional pores are connected with each other as micropores.

The carbonization may be performed in an inert atmosphere in a temperature range from 600° C. to 1,500° C.

The removing of the mesoporous silica may be performed by dipping the ordered mesoporous silica-carbon composite in a solvent to selectively dissolve the ordered mesoporous silica.

In the ordered mesoporous carbon-carbon nanotube composites manufactured according to the present invention, sheet resistance characteristics may be improved by allowing carbon nanotubes to interconnect ordered mesoporous carbon particles while structural properties of ordered mesoporous carbon are maintained as it is, thereby efficiently delivering electrical energy.

The mesoporous carbon-carbon nanotube nanocomposite according to the present may be used as a conductive material for the electrode of an energy conversion and storage device.

### BRIEF DESCRIPTION OF THE DRAWINGS

FIG. 1 is a view conceptually illustrating a process of forming ordered mesoporous carbon-carbon nanobutes according to an exemplary embodiment of the present invention.

FIG. 2 is a process diagram of manufacturing ordered mesoporous carbon-carbon nanotubes according to the present invention.

FIG. 3 is a scanning electron microscopic image of ordered mesoporous carbon-carbon nanotubes manufactured according to Example of the present invention.

FIG. 4 is a scanning electron microscopic image of oredered mesoporous carbons manufactured according to Comparative Example.

FIG. 5 is a transmission electron microscopic image of ordered mesoporous carbon-carbon nanotube nanocomposites manufactured according to Example of the present invention.

FIG. 6 is a graph showing low-angle X-ray diffraction results of ordered mesoporous carbon-carbon nanotube nanocomposites and ordered mesoporous carbons manufactured according to Example and Comparative Example of the present invention.

FIG. 7 is a graph showing high-angle X-ray diffraction results of ordered mesoporous carbon-carbon nanotube nanocomposites and ordered mesoporous carbons manufactured according to Example and Comparative Example of the present invention.

FIGS. 8 and 9 are a graph showing a nitrogen adsorption isotherm and a pore size distribution of ordered mesoporous carbon-carbon nanotube nanocomposites and ordered mesoporous carbons manufactured according to Example and Comparative Example of the present invention.

### DETAILED DESCRIPTION OF THE EMBODIMENTS

Advantages and features of the present invention and methods for achieving them will be made clear with reference to exemplary embodiments described below in detail in connection with the accompanying drawings. However, the present invention is not limited to exemplary embodiments described herein and may be implemented in various forms. The exemplary embodiments are provided by way of example only so that a person of ordinary skill in the art can fully understand the disclosures of the present invention and the scope of the present invention. Therefore, the present invention will be defined only by the scope of the appended claims. Like reference numerals refer to like elements throughout the specification.

Hereinafter, ordered mesoporous carbon-carbon nanotube nanocomposites according to an exemplary embodiment of the present invention will be described.

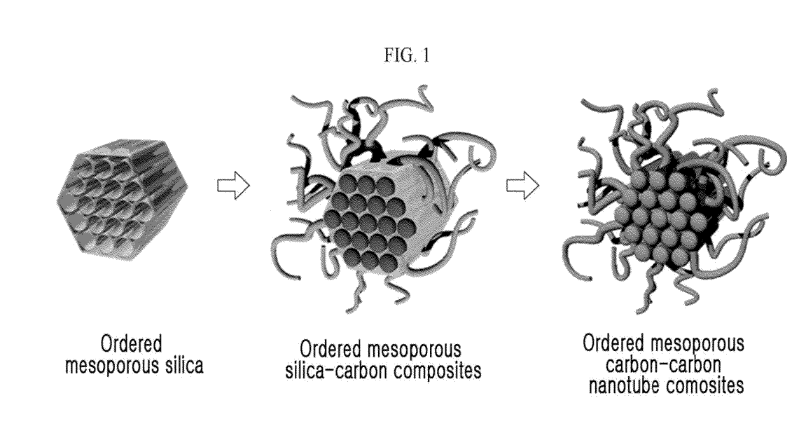

FIG. 1 is a view conceptually illustrating a process of forming ordered mesoporous carbon-carbon nanobutes according to an exemplary embodiment of the present invention.

The ordered mesoporous carbon-carbon nanotube nanocomposites according to the present invention have a structure in which ordered mesoporous carbons and carbon nanotubes are connected with each other.

The nanocomposites according the present invention have not only micropores but also mesopores at an appropriate ratio, compared to amorphous microporous carbon powders in the related art having only micropores.

Herein, according to IUPAC definition, micropores generally mean pores having a diameter of about 2 nm or less, and mesopores mean pores having a diameter of from 2 nm to 50 nm.

The mosopores have an average diameter of from 2 nm to 30 nm.

In applying the nanocomposites according to the present invention to a catalyst support for energy conversion and storage, when the average diameter of the mesopores is less than 2 nm, a fuel material supplied is not smoothly diffused, and thus limitations are imposed on the activity of the catalyst. When the average diameter of the mesopores is more than 30 nm, catalyst particles tend to become bigger during the manufacture of the catalyst and thus the efficiency of the catalyst is deteriorated, both of which are not preferred.

The nanocomposites have a specific surface area of from 200 m²/g to 2,000 m²/g and a sheet resistance of from 0.1 Ω/□ to 10 Ω/□.

When the specific surface area of the nanocomposites is less than 200 m²/g, it is difficult to increase the dispersity of metal particles supported when the nanocomposites are applied to a catalyst support for energy conversion and storage. When the specific surface area of the nanocomposites is more than 2,000 m²/g, an excessive amount of micropores are present, and thus diffusion characteristics of the fuel are deteriorated and the efficiency of the catalyst is deteriorated, both of which are not preferred.

The ordered mesoporous carbon-carbon nanotube nanocomposites of the present invention have a structure in which micropores of ordered mesoporous carbon are regularly arranged, and thus in an X-ray diffraction analysis, a main peak of Bragg angle (2θ) for a CuK-α characteristic X-ray wavelength 1.541 Å appears at least from 0.5° to 1.5°.

Additionally, one to two peaks or more which have a relatively weak intensity may appear at between 1.5° and 3°. When the positions of these peaks are used to perform a structural analysis, the structure (space group) of ordered mesoporous carbon parts may be understood.

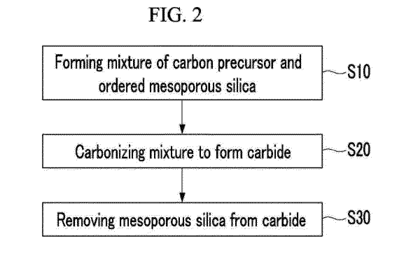

FIG. 2 is a process diagram of manufacturing ordered mesoporous carbon-carbon nanotubes according to the present invention. The method for manufacturing ordered mesoporous carbon-carbon nanotube nanocomposites according to another exemplary embodiment of the present invention includes forming a mixture of a carbon precursor and ordered mesoporous silica (S10); carbonizing the mixture to form a ordered mesoporous silica-carbon composite (S20); and removing the mesoporous silica from the ordered mesoporous silica-carbon composite (S30).

Referring to FIGS. 1 and 2, a carbon precursor is first introduced into an ordered mesoporous silica (OMS) template, and the resulting mixture is subjected to heat treatment (carbonization treatment) to form ordered mesoporous silica-carbon nanocomposites.

As used herein, the ordered mesoporous silica refers to a mesoporous silica having characteristics that pores are regularly arranged and XRD peaks at 2° or less appear.

Subsequently, ordered mesoporous silica may be removed from the ordered mesoporous silica (OMS)-carbon composites to obtain ordered mesoporous carbon-carbon nanotube nanocomposites in which ordered mesoporous carbons are connected with each other by carbon nanotubes.

More specifically, the carbon precursor is physically mixed with the ordered mesoporous silica, and then the resulting mixture is subjected to carbonization to form an ordered mesoporous silica (OMS)-carbon composite.

As the carbon precursor, a macrocyclic compound to which a metal ion is coordinated, selected from phthalocyanine, porphyrin, hemin and corrole.

The ordered mesoporous silica is a molecular material in which one-dimensional pores are connected with each other as micropores and the like, and is not particularly limited.

The ordered mesoporous silica is a molecular material having a three-dimensional connection structure, and MCM-48, SBA-1, SBA-6, SBA-16, KIT-5, KIT-6, FDU-1 and FDU-12, which have a cubic structure, SBA-15 which has a hexagonal structure, KIT-1 and MSU-1, which have a structure in which pores are irregularly and three-dimensionally connected, and the like are preferred.

In addition, as the ordered mesoporous silica, various kinds of molecular materials including various kinds of mesoporous molecular materials having a structure in which one-dimensional pores are connected with each other as micropores may be used.

The content of the ordered mesoporous silica mixed with the precursor is preferably from 50 parts by weight to 300 parts by weight based on 100 parts by weight of the carbon precursor.

When the content of the ordered mesoporous silica is less than 50 parts by weight, the relative amount of the precursor mixture extremely increases and aggregation between particles increases, thereby decreasing the surface area. When the content of the ordered porous silica is more than 300 parts by weight, the relative content of the precursor is so low that a carbon structure may not be sufficiently formed within the silica pore, which is a problem.

The mixture temperature is not particularly limited, but is performed preferably at room temperature.

The product as mixed above is subjected to carbonization to be structured with carbon.

That is, a carbon precursor incorporated into the ordered mesoporous silica, which serves as a template, is structured while being graphitized by a carbonization process, and a carbon precursor adsorbed on the surface of the ordered mesoporous silica forms carbon nanotubes at the carbonization temperature.

The carbonization is performed by using a heating means such as an electric furnace and the like to perform a heat treatment at a temperature of from 600° C. to 1,500° C.

If the carbonization temperature is less than 600° C., complete graphitization does not occur, and thus carbons may be incompletely structured. If the carbonization temperature is more than 1,500° C., thermal decomposition of carbons may occur, or the structure of the silica which serves as a template may be modified.

The carbonization is preferably performed in a non-oxidizing atmosphere. The non-oxidizing atmosphere may be selected from vacuum atmosphere, nitrogen atmosphere and inert gas atmosphere.

Next, a solvent capable of selectively dissolving the ordered mesoporous silica from the ordered mesoporous silica (OMS)-carbon composites is used to remove the ordered mesoporous silica.

The solvent capable of selectively dissolving the ordered mesoporous silica includes, for example, a hydrofluoric (HF) acid aqueous solution, sodium hydroxide (NaOH) solution or the like.

Here, the concentration of the hydrofluoric acid aqueous solution is from 5 wt % to 47 wt %, and the concentration of the sodium hydroxide aqueous solution is from 5 wt % to 30 wt %.

It is known that the ordered mesoporous silica becomes a soluble silicate by alkali melting, carbonate dissolution or the like and is reacted with hydrofluoric (HF) acid to form SiF4, which is easily eroded.

The ordered mesoporous carbon-carbon nanotube nanocomposites may be separated by removing the ordered mesoporous silica.

Hereinafter, the ordered mesoporous carbon-carbon nanotube nanocomposites according to the present invention will be described in detail through Examples. However, the following Examples are provided only for illustrating the present invention, and the present invention is not limited by the following Examples.

### EXAMPLE

### Manufacture of Ordered Mesoporous Carbon-Carbon Nanotube Composites

1 g of nickel phthalocyanine was physically mixed with 1 g of SBA-15 which is a kind of ordered mesoporous silica at room temperature. The mixture of nickel phthalocyanine and SBA-15 mixed as above was placed into a tubular electric furnace and heated under nitrogen atmosphere to perform a carbonization treatment at 900° C.

The product carbonized as described above is added to a mixed solution of HF, water and ethanol, and a process of stirring the resulting mixture was repeated to remove SBA-15, thereby manufacturing the ordered mesoporous carbon-carbon nanotube composites.

### COMPARATIVE EXAMPLE

### Manufacture of Ordered Mesoporous Carbons

An ordered mesoporous carbon was manufactured by performing the carbonization treatment in the same manner as in Example, except that phthalocyanine molecules in which nickel is not included as a carbon precursor were used.

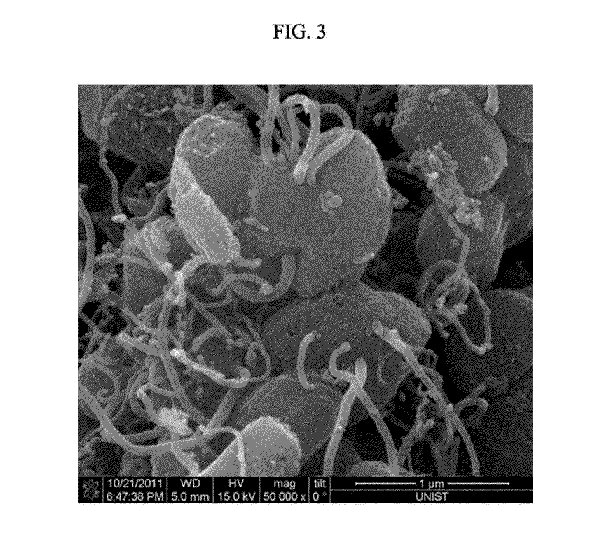

FIG. 3 is a scanning electron microscopic image of ordered mesoporous carbon-carbon nanotube nanocomposites synthesized by Example and shows that particles of ordered mesoporous carbon are connected as a network structure by carbon nanotubes.

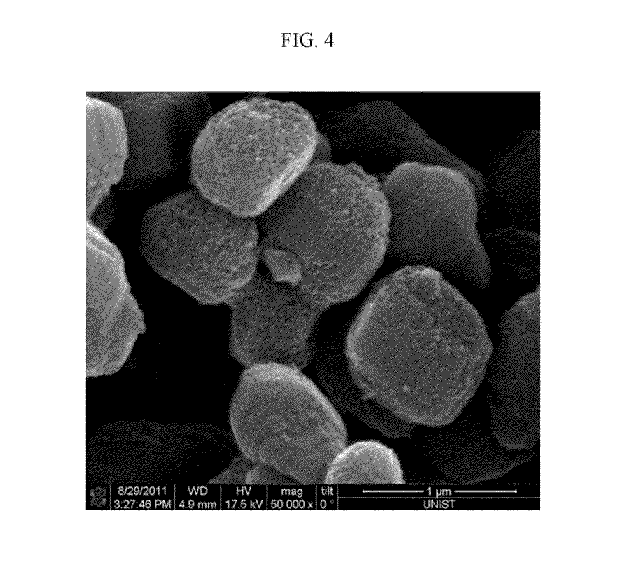

FIG. 4 is a scanning electron microscopic image of ordered mesoporous carbons synthesized by Comparative Example, and it can be known that the synthesized carbon material did not include carbon nanobutes and consisted only of ordered mesoporous carbon particles.

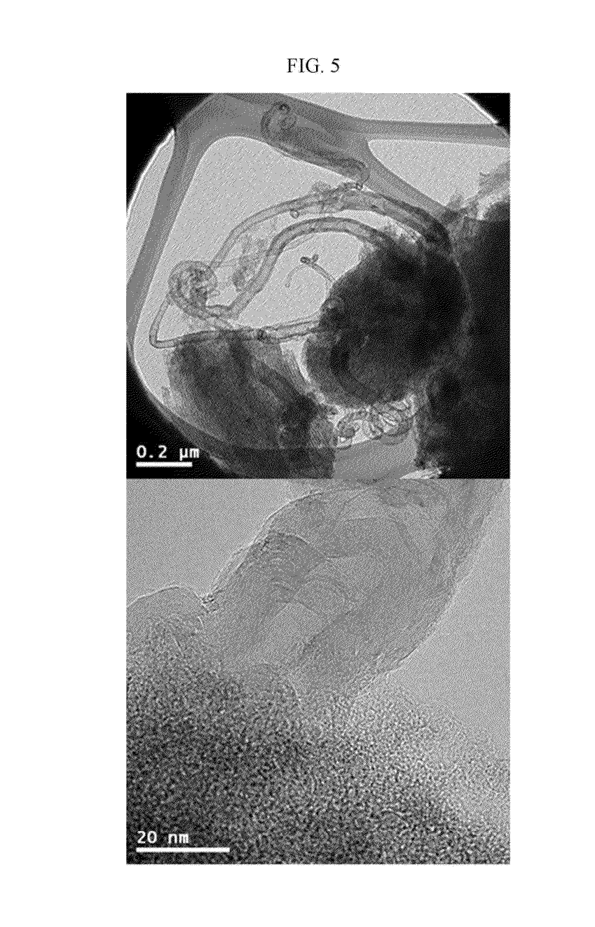

FIG. 5 is a transmission electron microscopic image of ordered mesoporous carbon-carbon nanotube nanocomposites synthesized by Example, and shows that carbon nanotubes are embedded in ordered carbon particles.

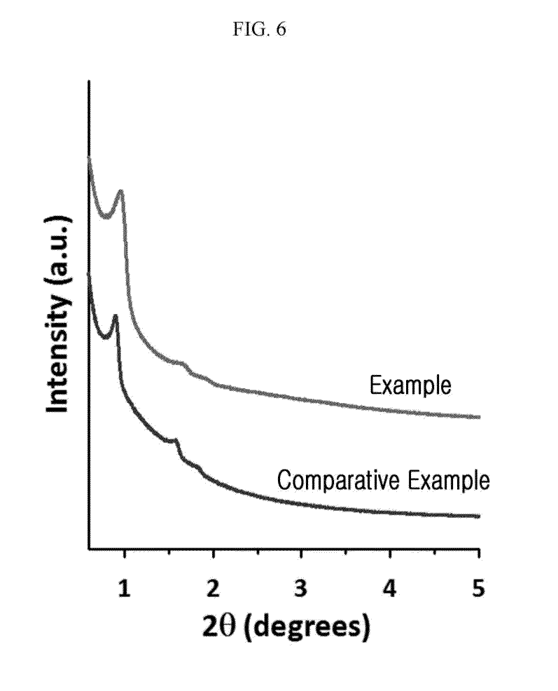

FIG. 6 illustrates low-angle X-ray diffraction forms of materials synthesized by Example and Comparative Example of the present invention, and it can be known that main peaks of ordered mesoporous carbon-carbon nanotube nanocomposites synthesized by Example and ordered mesoporous carbons synthesized by Comparative Example all appear at 0.9°.

From this, it can be confirmed that a structural regularity at the meso region is maintained even though ordered carbons form carbon nanotubes and nanocomposites.

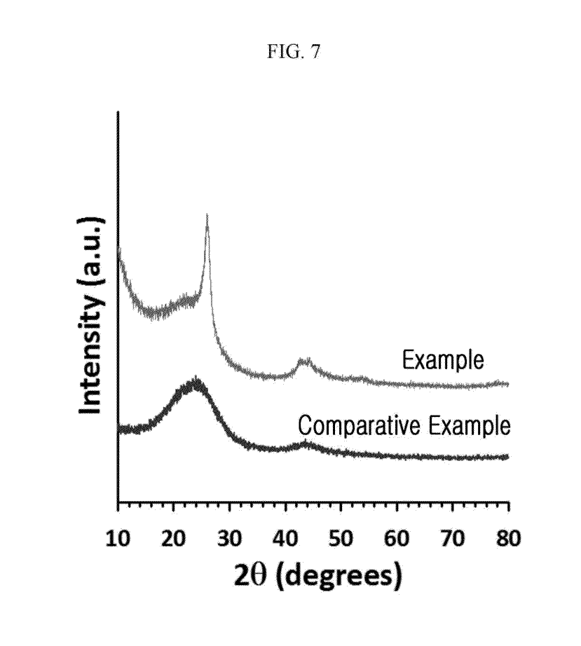

FIG. 7 illustrates high-angle X-ray diffraction forms of materials synthesized by Example and Comparative Example of the present invention, and ordered mesoporous carbon-carbon nanotube nanocomposites synthesized by Example show a peak having a very narrow line width and a strong intensity in the vicinity of 26°. This is a peak produced by a graphitized carbon layer of carbon nanotubes, meaning that carbon nanotubes are present in the composites.

On the contrary, in the case of ordered mesoporous carbons synthesized by Comparative Example, a peak having a very wide line width at between 22° and 26° appears, meaning that the backbone of the ordered mesoporous carbons consisted of amorphous carbon backbones.

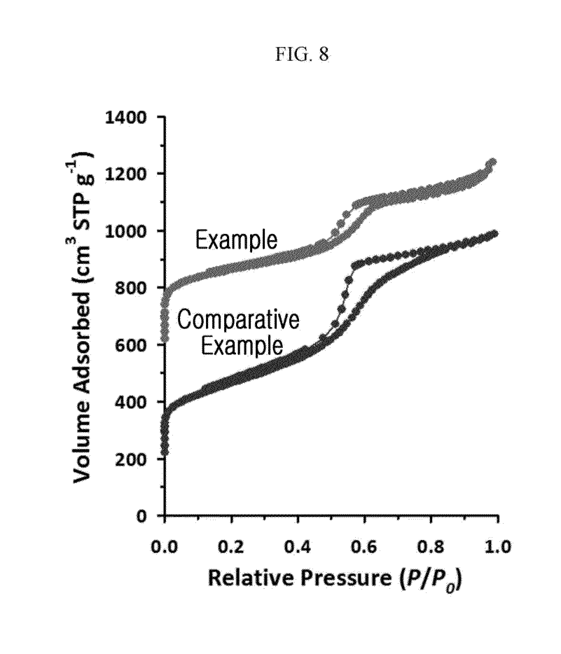

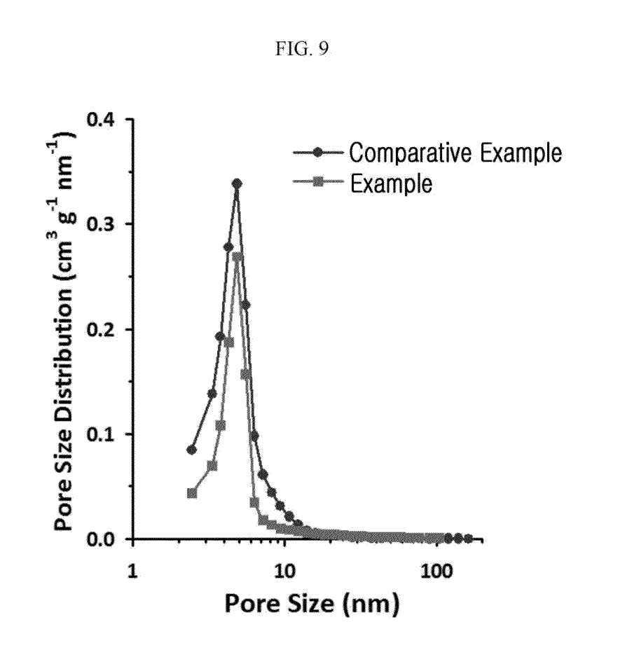

FIGS. 8 and 9 illustrate a nitrogen adsorption isotherm and a pore size distribution from this, respectively, and it can be known that ordered mesoporous carbon-carbon nanotube nanocomposites synthesized by Example and ordered mesoporous carbons synthesized by Comparative Example all show similar adsorption isotherms and pore size distributions.

This means that the pore structure of ordered mesoporous carbons had not been greatly changed and was maintained as it was even though ordered mesoporous carbons and carbon nanotubes formed composites.

The surface area, pore volume, pore diameter and sheet resistance values of the synthesized materials in Example and Comparative Example are shown in the following Table 1.

TABLE 1

| | BET | Pore | Pore | Sheet |
|---|---|---|---|---|
| | surface | volume | diameter | resistance |
| | area (m²/g) | (cm³/g) | (nm) | (Ω/□) |
| Example | 940 | 0.99 | 4.9 | 8 |
| Comparative | 951 | 1.22 | 4.9 | 10-100 |
| Example | | | | |

From the Table 1, it can be known that no significant change in the surface area and pore volume size was observed and the pore volume was slightly decreased even though carbon nanotubes formed composites in ordered mesoporous carbons from synthesized materials obtained by Example and Comparative Example.

From the Table 1, it can be known that materials synthesized by Example and Comparative Example showed sheet resistance values of 8 (Ω/□) and from 10 (Ω/□) to 100 (Ω/□), respectively and thus ordered mesoporous carbon-carbon nanotube nanocomposites obtained from Example showed higher electric conductivity than that of ordered mesoporous carbons obtained in Comparative Example.

While Example of the present invention has been described with reference to the accompanying drawings, it is to be understood by a person of ordinary skill in the art to which the present invention belongs that the present invention may be performed in other specific forms without modifying the technical spirit or essential features thereof.

Therefore, it is to be understood that the embodiments described above are illustrative and not restrictive in all of the aspects. The scope of the present invention is shown by the claims to be described below rather than the detailed description, and it is to be construed that the meaning and scope of the claims and all modifications or modified forms derived from the equivalent concept thereof are encompassed within the scope of the present invention.

What is claimed is:

1. Ordered mesoporous carbon-carbon nanotube nanocomposites having a structure in which ordered mesoporous carbons having mesopores and carbon nanotubes are connected with each other.

2. The ordered mesoporous carbon-carbon nanotube nanocomposites of claim 1, wherein:
the mesopores have an average diameter of from 2 nm to 30 nm.

3. The ordered mesoporous carbon-carbon nanotube nanocomposites of claim 1, wherein:
the nanocomposites have a specific surface area of from 200 m²/g to 2,000 m²/g and a sheet resistance of from 0.1 Ω/□ to 10 Ω/□.

4. The ordered mesoporous carbon-carbon nanotube nanocomposites of claim 1, wherein:
when the nanocomposites are subjected to x-ray diffraction analysis,
a main peak of Bragg angle (2θ) for a CuK-α characteristic X-ray wavelength 1.541 Å appears at from 0.5 to 1.5.

5. A method for manufacturing ordered mesoporous carbon-carbon nanotube nanocomposites, comprising:
forming a mixture of a carbon precursor and ordered mesoporous silica;
carbonizing the mixture to form a ordered mesoporous silica-carbon composite; and
removing the mesoporous silica from the ordered mesoporous silica-carbon composite.

6. The method of claim 5, wherein:
a content of the ordered mesoporous silica mixed with the carbon precursor is from 50 parts by weight to 300 parts by weight based on 100 parts by weight of the carbon precursor.

7. The method of claim 5, wherein:
the carbon precursor is at least one macrocyclic compound to which a metal ion is coordinated, selected from phthalocyanine, porphyrin, hemin and corrole.

8. The method of claim 5, wherein:
the ordered mesoporous silica is a molecular material having a three-dimensional connection structure and is at least one selected from MCM-48, SBA-1, SBA-6, SBA-16, KIT-5, KIT-6, FDU-1 and FDU-12, which have a cubic structure, SBA-15 which has a hexagonal structure, KIT-1 and MSU-1, which have a structure in which pores are irregularly and three-dimensionally connected.

9. The method of claim 5, wherein:
the ordered mesoporous silica is mesoporous molecular material having a structure in which uniform mesopores are interconnected each other.

10. The method of claim 5, wherein:
the carbonization is performed in an inert atmosphere in a temperature range of 600° C. to 1,500° C.

11. The method of claim 5, wherein:
the removing of the mesoporous silica is performed by dipping the ordered mesoporous silica-carbon composite in a solvent to selectively dissolve the ordered mesoporous silica.
